(19) United States
(12) Patent Application Publication
(10) Pub. No.: US 2026/0135287 A1
(43) Pub. Date: May 14, 2026

(54) ANTENNA HOLDER

(71) Applicant: Xue-Feng Chen, Guangzhou City (CN)

(72) Inventor: Xue-Feng Chen, Guangzhou City (CN)

(21) Appl. No.: 18/946,843

(22) Filed: Nov. 13, 2024

(51) Int. Cl. H01Q 1/12

(52) U.S. Cl. CPC H01Q 1/125

(57) ABSTRACT

An antenna holder with an angle adjustment structure is provided. The antenna holder includes a rod, an angle adjustment set, and an antenna accommodating member. The rod includes a fastener hole at one end. The angle adjustment set includes a base, an adjustment seat, a shaft member, and a limiting member. The base is engaged to the fastener hole with a connecting member. One side of the base includes an upward adjusting portion with a first pivot hole and a through hole. One side of the adjustment seat includes a downward adjusting portion with a second pivot hole and an arc-shaped guiding slot. The shaft member passes through the first pivot hole and the second pivot hole, and the limiting member passes through the through hole and the arc-shaped guiding slot. The antenna accommodating member is disposed on a top of the adjusting seat.

### FIELD OF THE DISCLOSURE

The present disclosure relates to an antenna holder, and more particularly, to an antenna holder to accommodate antenna dishes in router systems.

### BACKGROUND OF THE DISCLOSURE

Routers are widely used in houses to provide network signals at home. Some models even provide the function of enhancing the signal. To provide the Internet, a router must be matched with other equipment to build a complete system. For example, the Starlink router includes an antenna disk, a host, and a power supply, and the host is connected between the antenna disk and the power supply. The advantage is that as long as the antenna dish is not covered, the user can obtain stable network speed at any time, no matter where the user is.

Regarding the settings of Starlink routers, the antenna dish is generally installed outdoors, such as on the roof of a building, and the antenna dish should be free of any coverings, while the host and power supply only need to be installed inside the house. The most common installation method for antenna dishes is to use a holder to fix the antenna dish on the roof. However, the holder currently on the market only has the function of supporting and has some shortcomings.

Specifically, there is an optimal receiving angle for setting up the antenna dish, but not every building has the same setting conditions; for example, the roof's shape and tilt angle are different. Therefore, without the optimal receiving angle, the reception angle of the antenna dish with the holder may not be ideal, causing the performance of the entire router system to decrease.

Recognizing the limitations of current antenna dish holders, it's evident that they often fail to provide optimal reception angles.

### SUMMARY OF THE DISCLOSURE

In order to address the conventional problem, the present disclosure provides an antenna holder with an angle adjustment set between the antenna accommodating member and the rod. This design allows the user to adjust the tilt angle of the antenna dish, ensuring the best signal-receiving angle. Unlike conventional products, the signal-receiving angle is not limited by the setup of the antenna dish. The practicality of this design is indeed a novel and inventive solution.

The present disclosure provides an angle-adjustable antenna holder. The antenna holder includes a rod, an angle adjustment set, and an antenna accommodating member. The rod includes a fastener hole at one end. The angle adjustment set includes a base, an adjustment seat, a shaft member, and a limiting member; wherein the base is engaged to the fastener hole with a connecting member; wherein one side of the base includes an upward adjusting portion having a first pivot hole and a through hole arranged in a vertical arrangement; wherein one side of the adjustment seat includes a downward adjusting portion having a second pivot hole and an arc-shaped guiding slot arranged in a vertical arrangement; wherein the shaft member passes through the first pivot hole and the second pivot hole, and the limiting member passes through the through hole and the arc-shaped guiding slot. The antenna accommodating member is disposed on a top of the adjusting seat.

In certain embodiments, the antenna accommodating member has a first cable hole; wherein the rod is hollow and has a second cable hole.

In certain embodiments, both upper and lower sides of the second cable hole are in a filleted-guiding shape.

In certain embodiments, the downward adjusting portion of the adjusting seat is semicircular.

In certain embodiments, the upward adjusting portion of the base is triangular and has a rounded top.

In certain embodiments, a top of the adjustment base has a plurality of threaded holes, and the plurality of threaded holes are disposed in a circular arrangement; wherein the antenna accommodating member is threadedly engaged to the plurality of threaded holes of the adjustment base with a plurality of screws.

In certain embodiments, when the adjustment seat is tilted downward relative to the base until the adjustment seat abuts the base, an included angle is provided between the base and the antenna accommodating member, and the included angle is between 115 and 125 degrees.

### BRIEF DESCRIPTION OF THE DRAWINGS

The described embodiments may be better understood by reference to the following description and the accompanying drawings in which:

FIG. 1 is a perspective schematic view of one embodiment of the present disclosure;

FIG. 2 is an exploded schematic view of the structure of the present disclosure.

FIG. 3 is a schematic view of the antenna holder of the present disclosure in practice;

FIG. 4 is a sectional schematic view of the antenna holder of the present disclosure in practice;

FIG. 5 is a schematic view of the adjustment to the angle of the antenna holder of the present disclosure in practice;

FIG. 6 is a sectional schematic view of line VI-VI of FIG. 1; and

FIG. 7 is a schematic view of the adjustment seat tilting downward to abut on the base of the present disclosure.

### DETAILED DESCRIPTION OF THE EXEMPLARY EMBODIMENTS

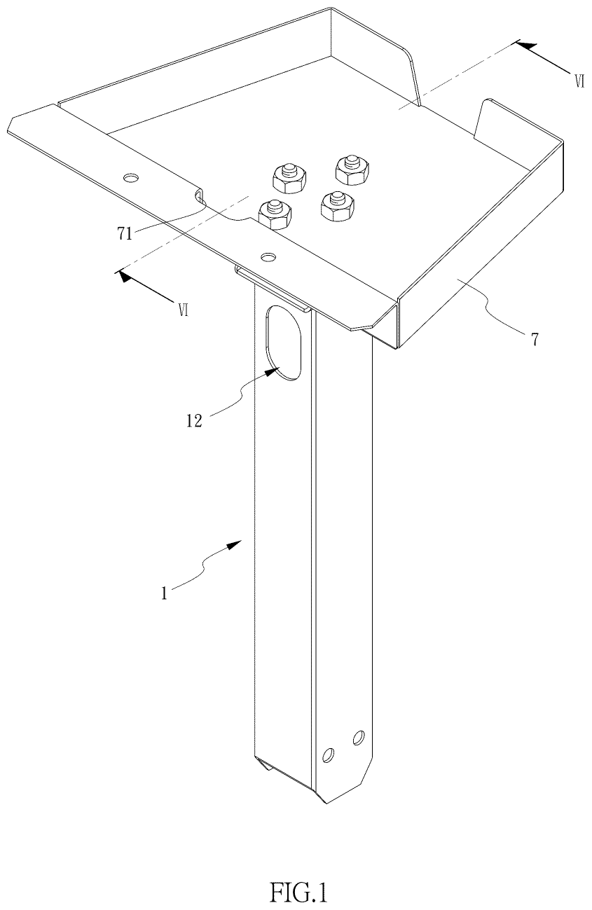

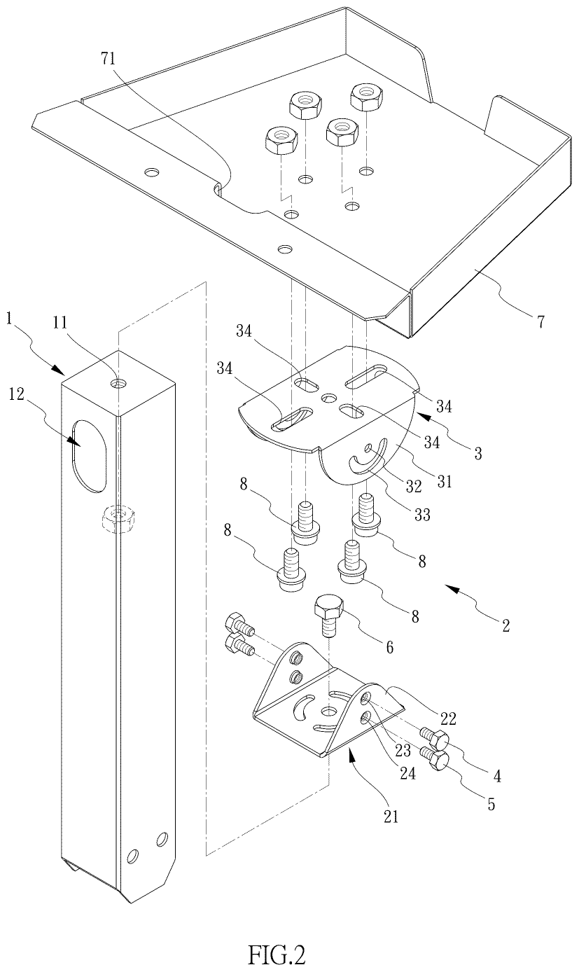

For the sake of a detailed understanding of the embodiments of the present disclosure, the description can be read in conjunction with the drawings. As shown in FIG. 1 to FIG. 5. The present disclosure provides an angle-adjustable antenna holder, the antenna holder includes a rod 1, an angle adjustment set 2, and an antenna accommodating member 7. The rod 1 includes a threaded hole 11 at one end. The angle adjustment set 2 includes a base 21, an adjustment seat 3, a shaft member 4, and a limiting member 5. In detail, the base 21 is engaged to the fastener hole 11 with a connecting member 6. Further, one side of the base 21 includes an upward adjusting portion 22 with a first pivot hole 23 and a through hole 24 arranged vertically. One side of the adjustment seat 3 includes a downward adjusting portion 31 with a second pivot hole 32 and an arc-shaped guiding slot 33 arranged vertically. Furthermore, the shaft member 4 passes through the first pivot hole 23 and the second pivot hole 32, and the limiting member 5 passes through the through hole 24 and the arc-shaped guiding slot 33. The antenna accommodating member 7 is disposed on a top of the adjusting seat 3.

It should be understood that although the preferred embodiments are shown and described above, the present disclosure is not limited to the specific embodiments described above, and various modifications and variations can be made by those skilled in the art without departing from the spirit and scope of the appended claims. Therefore, it should be noted that various modifications and variations cannot be considered beyond the technical spirit and scope of the present disclosure.

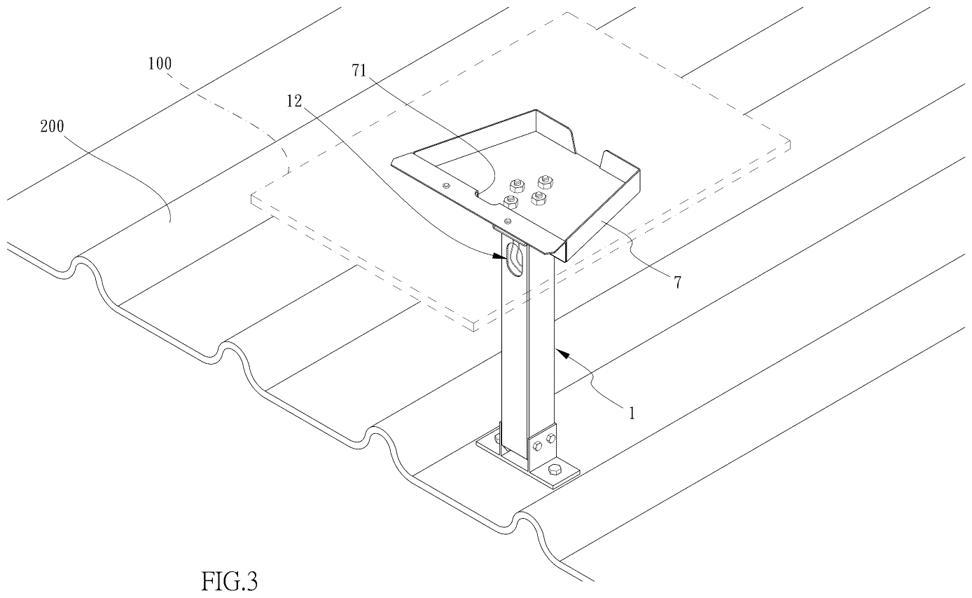

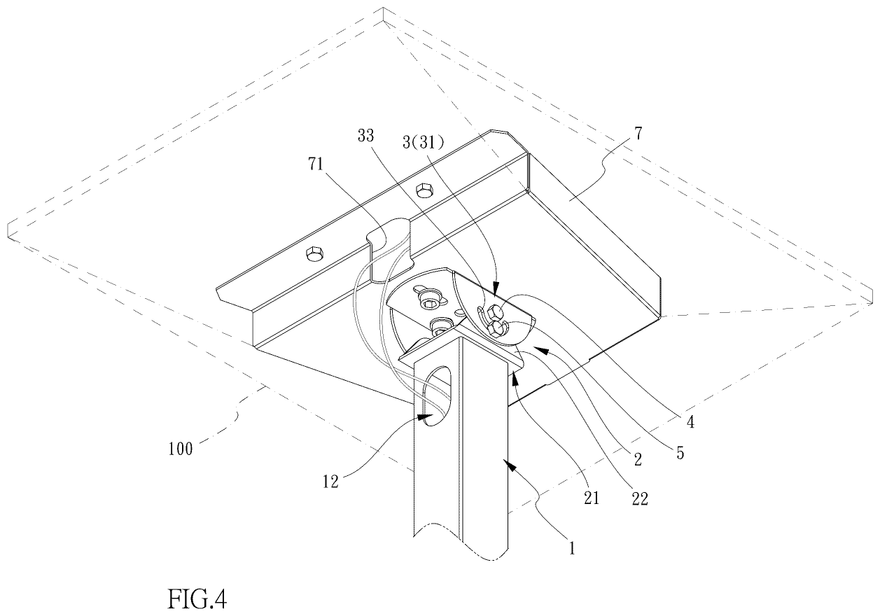

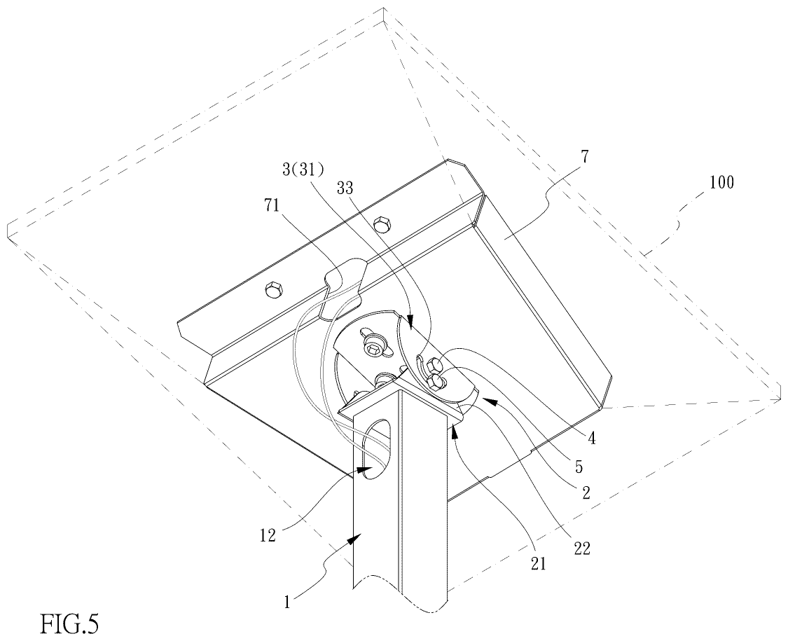

In order to improve the conventional problem, the present disclosure provides an antenna holder including an angle adjustment set 2 between the antenna accommodating member 7 and the rod 1. The practical application of the present disclosure is shown in FIG. 3. After the antenna holder of the present disclosure is disposed on the roof 200 and the antenna dish 100 is assembled, as shown in FIG. 4 and FIG. 5, the tilt angle of the antenna dish 100 can be adjusted according to the needs to achieve the best signal receiving angle of the antenna dish 100. In addition, the limiting member 5 can be a combination of bolts and nuts according to requirements. After completing the angle adjustment of the adjusting seat 3 relative to the base 21 of the angle adjustment set 2, the bolts and nuts are threadedly engaged to effectively prevent the tilt angle from being affected by outside factors, such as impact from objects, strong wind, etc.

In conventional products, the signal-receiving angle may be caused by the setup of the antenna dish 100. The angle adjustment set 2 of the present disclosure improves the shortcomings mentioned above of conventional products. Therefore, the antenna holder of the present disclosure is indeed more practical, novel, and inventive.

As shown in FIG. 4 and FIG. 5, the antenna accommodating member 7 further has a first cable hole 71, the rod 1 is hollow and has a second cable hole 12. The first cable hole 71 and the second cable hole 12 can hide most of the cables of the antenna dish 100 inside rod 1 and the antenna accommodating member 7; thereby, the exposure of the wires of antenna dish 100 can be minimized. Furthermore, both the upper and lower sides of the second cable hole 12 are in a filleted-guiding shape. Therefore, the friction between the cables in the antenna dish 100 and the second cable hole 12 is reduced.

In certain embodiments, the downward adjusting portion 31 of the adjusting seat 3 is semicircular. In certain embodiments, the upward adjusting portion 22 of the base 21 is triangular and has a rounded top. This structure can reduce the interference between the adjustment seat 3 and the base 21 while adjusting the angle adjustment set 2.

Further, a top of the adjustment base 3 has a plurality of threaded holes 34, and the plurality of threaded holes 34 are disposed in a circular arrangement. The antenna accommodating member 7 is threadedly engaged to the adjustment base 3 through the threaded holes 34 and a plurality of screws 8. The plurality of threaded holes 34 are threadedly engaged to the plurality of screws 8, and the circular arrangement allows the antenna accommodating member 7 and the adjustment seat 3 to be more stable.

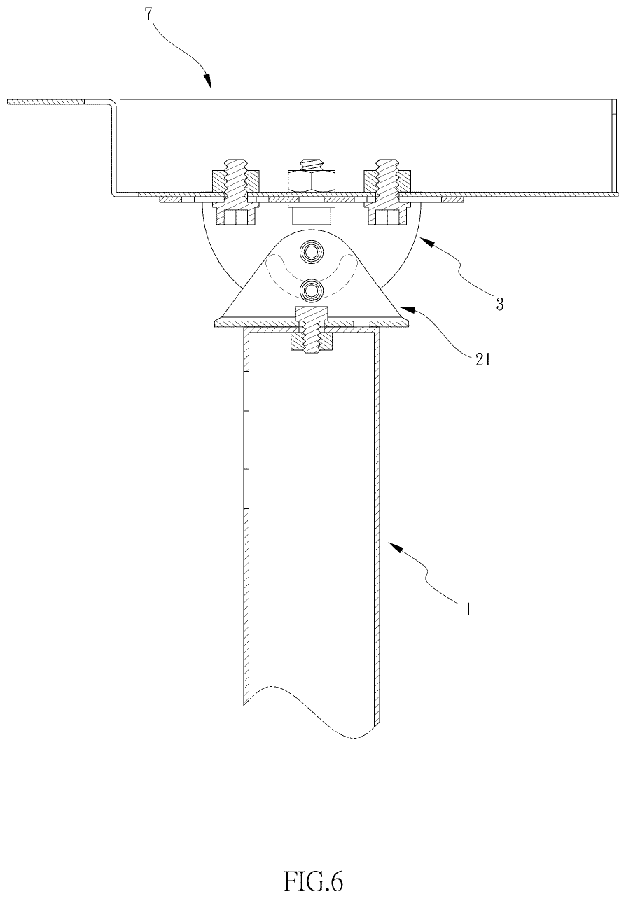

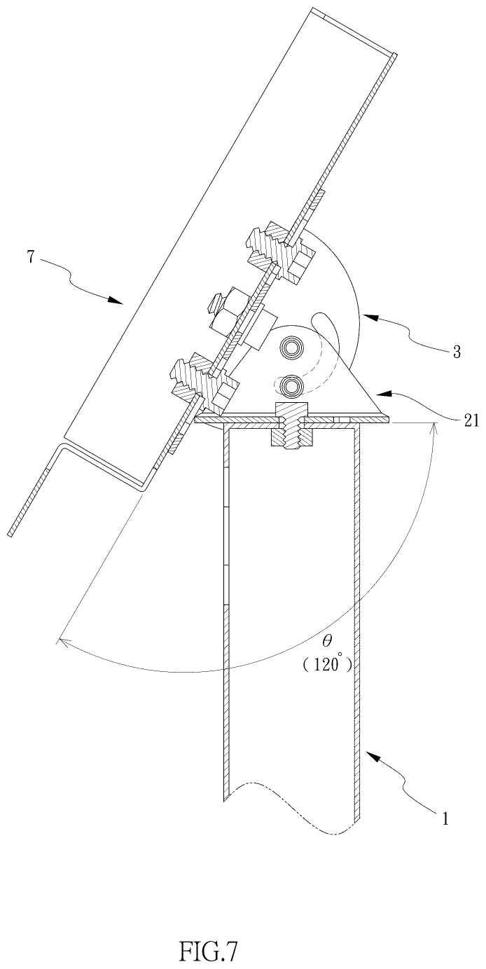

Furthermore, as shown in FIG. 6 and FIG. 7, when the adjustment seat 3 is tilted downward relative to the base 21 until the adjustment seat 3 abuts the base 21, an included angle θ is provided between the base 21 and the antenna accommodating member 7, and the included angle θ is between 115 to 125 degrees. Preferably, the included angle θ is an integer between 115 to 125 degrees. More preferably, the included angle θ is 120 degrees.

Moreover, one of the technical features of the present disclosure is that the adjusting seat 3 tilts downward to abut against the base 21 and is limited, the structure can prevent the antenna accommodating member 7 from suddenly tilting downward due to outside factors (impact from objects, strong wind, etc.), causing excessive swing and a powerful impact that may cause damage to the structure.

What is claimed is:

1. An antenna holder, comprising:
a rod, including a fastener hole at one end;
an angle adjustment set, including a base, an adjustment seat, a shaft member, and a limiting member; wherein the base is engaged to the fastener hole with a connecting member; wherein one side of the base includes an upward adjusting portion having a first pivot hole and a through hole arranged in a vertical arrangement; wherein one side of the adjustment seat includes a downward adjusting portion having a second pivot hole and an arc-shaped guiding slot arranged in a vertical arrangement; wherein the shaft member passes through the first pivot hole and the second pivot hole, and the limiting member passes through the through hole and the arc-shaped guiding slot; and
an antenna accommodating member, disposed on a top of the adjusting seat.

2. The antenna holder according to claim 1, wherein the antenna accommodating member has a first cable hole; wherein the rod is hollow and has a second cable hole.

3. The antenna holder according to claim 2, wherein both upper and lower sides of the second cable hole are in a filleted-guiding shape.

4. The antenna holder according to claim 1, wherein the downward adjusting portion of the adjusting seat has two downward fins in a semicircular shape.

5. The antenna holder according to claim 1, wherein the upward adjusting portion of the base has two upward fins being triangular and has a rounded top.

6. The antenna holder according to claim 1, wherein a top of the adjustment base has a plurality of threaded holes, and the plurality of threaded holes are disposed in a circular arrangement; wherein the antenna accommodating member is threadedly engaged to the plurality of threaded holes of the adjustment base with a plurality of screws.

7. The antenna holder according to claim 1, wherein when the adjustment seat is tilted downward relative to the base until the adjustment seat abuts the base, an included angle is provided between the base and the antenna accommodating member, and the included angle is between 115 to 125 degrees.
